(19) United States
(12) Patent Application Publication
(10) Pub. No.: US 2025/0320881 A1
(43) Pub. Date: Oct. 16, 2025

(54) Hydraulic Control Device

(71) Applicant: Kubota Corporation, Osaka-shi (JP)

(72) Inventors: Ryosuke Oyanagi, Sakai-shi, Osaka (JP); Seimei Nishikawa, Sakai-shi, Osaka (JP); Yuichi Nagatomi, Sakai-shi, Osaka (JP); Hiroki Suga, Sakai-shi, Osaka (JP)

(21) Appl. No.: 18/867,283

(22) PCT Filed: Mar. 28, 2023
(86) PCT No.: PCT/JP2023/012382

§ 371 Date: Nov. 19, 2024

(30) Foreign Application Priority Data
Jun. 28, 2022 (JP) 2022-103555

(51) Int. Cl. F15B 13/044; F15B 13/04; F16K 31/40

(52) U.S. Cl. CPC F15B 13/044; F15B 13/0401; F16K 31/406

(57) ABSTRACT

An oil pressure control device has a neutral position, a first operation position, and a second operation position. The second operation position is performed without performing an operation corresponding to the first operation position from the neutral position. An electromagnetic proportional valve switches a switching control valve. A control unit controls the electromagnetic proportional valve based on an operation command of an operation tool. A mode stitching switch is provided to switch a control mode. The operation tool is operable to a one-sided region, a neutral region, and an other-side region. The control unit supplies a current value corresponding to an other-side first operation position to the electromagnetic proportional valve when the operation tool is operated to the other-side region. The control unit supplies a current value corresponding to an other-side second operation position to the electromagnetic proportional value when the operation tool is operated to the other-side region.

### CROSS-REFERENCE TO RELATED APPLICATIONS

This application is the United States national phase of International Patent Application No. PCT/JP2023/012382 filed Mar. 28, 2023, and claims priority to Japanese Patent Application No. 2022-103555 filed Jun. 28, 2022, the disclosures of which are hereby incorporated by reference in their entireties.

### BACKGROUND OF THE INVENTION

### Field of the Invention

The present invention relates to a hydraulic control device that is used in, for example, a work vehicle and controls supply and discharge of hydraulic oil.

### Description of Related Art

As the work vehicle provided with the hydraulic control device, there is a work vehicle in which a front loader is provided on a vehicle body of a tractor. In a hydraulic control device used for this type of work vehicle, a bucket is swingably attached to a boom, and a hydraulic cylinder that swings the bucket, a switching control valve that controls the hydraulic cylinder, and an operation tool that switches the switching control valve by a manual operation are provided (for example, see Japanese Patent Application Laid-Open No. 2004-285564 (JP 2004-285564)).

In JP 2004-285564, the switching control valve is configured to be operated to a rollback position where the bucket is able to scoop up soil, sand, and the like, a neutral position where the hydraulic oil is not supplied and discharged to and from the hydraulic cylinder, a rapid operation position where the bucket is rapidly operated to quickly discharge soil, sand, and the like, and a standard speed position where the bucket is operated to discharge soil, sand, and the like at a standard speed.

In the hydraulic control device described in JP 2004-285564, the rollback position (one-side operation position), the neutral position, the rapid operation position (other-side first operation position), and the standard speed position (other-side second operation position) are disposed in this order. Therefore, the bucket is able to be rapidly operated by operating the operation tool from the neutral position to the rapid operation position to discharge soil, sand, and the like from the bucket. After that, the operation tool is further operated to the standard speed position to enable the operation of the bucket at the standard speed.

However, in the above-described conventional configuration, even in a case where the other-side second operation position is to be directly operated from the neutral position, the other-side first operation position needs to be temporarily passed through, and thus, an intended operation may not be performed. For example, in a case of JP 2004-285564, since the bucket cylinder is always rapidly operated in a case where the operation tool at the neutral position is operated to discharge soil, sand, and the like from the bucket, it is difficult to operate the operation tool in a case where soil, sand, and the like are discharged at a standard speed. In addition, in JP 2004-285564, the other-side first operation position is assigned to the rapid operation position and the other-side first operation position is assigned to the standard speed position. However, there is a case where it is desired to perform an operation corresponding to the other-side second operation position without performing an operation of the other-side first operation position even in a case where other operations are assigned to the other-side first operation position and the other-side second operation position. In addition, for example, in a case where the bucket is used by being replaced with another work tool, the other-side first position is not necessary, and there is a case where it is desired to switch directly from the neutral position to the other-side second position.

### SUMMARY OF THE INVENTION

The present invention is made in view of the above-described problems, and an object of the present invention is to enable a hydraulic control device in which a neutral position, a first operation position, and a second operation position are disposed in this order to perform an operation corresponding to the second operation position without performing an operation corresponding to the first operation position from the neutral position.

A feature configuration of a hydraulic control device according to the present invention is that the hydraulic control device includes a switching control valve configured to switch a supply and discharge state of hydraulic oil; at least one electromagnetic proportional valve configured to be used for a switching operation of the switching control valve; a control unit configured to control an operation of the electromagnetic proportional valve based on an operation command of an operation tool; and mode switching means configured to switch a control mode of the control unit between a first mode and a second mode, in which the operation tool is capable of being operated to a one-side region, a neutral region, and an other-side region, the switching control valve is capable of being switched between a one-side operation position where the switching control valve is switched in response to an operation of the operation tool to the one-side region, a neutral position where the switching control valve is switched when the operation tool is not operated, an other-side first operation position where the switching control valve is switched when the operation tool is operated to the other-side region, and an other-side second operation position where the switching control valve is switched when the operation tool is operated to the other-side region, which is different from the first operation state, and the control unit is configured to supply a current value corresponding to the other-side first operation position to the electromagnetic proportional valve when the operation tool is operated from the neutral position to the other-side region in the first mode, and supply a current value corresponding to the other-side second operation position to the electromagnetic proportional valve when the operation tool is operated from the neutral position to the other-side region in the second mode.

According to the present invention, if the first mode is set by the mode switching means, when the operation tool is operated from the neutral position to the other-side region, the switching control valve is operated to be switched to the other-side first operation position by the operation of the electromagnetic proportional valve. On the other hand, if the second mode is set by the mode switching means, when the operation tool is operated from the neutral position to the other-side region, the switching control valve is operated to be switched to the other-side second operation position by the operation of the electromagnetic proportional valve. That is, in the first mode, the switching control valve is able to be switched to three positions of the one-side operation position, the neutral position, and the other-side first operation position based on the operation of the operation tool, and in the second mode, the switching control valve is able to be switched to three positions of the one-side operation position, the neutral position, and the other-side second operation position based on the operation of the operation tool.

As described above, the operation mode is switched by the mode switching means, and the current value with respect to the electromagnetic proportional valve is changed, so that the supply and discharge state of the hydraulic oil is able to be switched to different states. Therefore, in the hydraulic control device in which the neutral position, the other-side first operation position, and the other-side second operation position are disposed in this order, it is possible to perform an operation corresponding to the other-side second operation position without performing an operation corresponding to the other-side first operation position from the neutral position.

In the present invention, the switching control valve may switch the supply and discharge state of the hydraulic oil with respect to a hydraulic actuator from a hydraulic pump, switch the supply and discharge state to operate the hydraulic actuator in a first operation direction at the one-side operation position, switch the supply and discharge state to operate the hydraulic actuator in a first operation state in a second operation direction at the other-side first operation position, and switch the supply and discharge state to operate the hydraulic actuator in a second operation state different from the first operation state in the second operation direction at the other-side second operation position.

According to the present configuration, for example, to switch the operation state of the hydraulic actuator to the first operation state and the second operation state when the operation tool is operated from the neutral region to the other-side region, in addition to the switching control valve, a complicated configuration such as separately providing a dedicated control valve, a check valve, or the like for flow passage switching, is not necessary, and there is little concern that the configuration will be complicated.

Therefore, it is possible to easily switch the operation state of the hydraulic actuator without complicating the configuration.

In the present invention, the hydraulic actuator may be a hydraulic cylinder, the first operation state may be a high-speed operation state where the hydraulic cylinder is operated at a high speed, and the second operation state may be a low-speed operation state where the hydraulic cylinder is operated at a low speed.

According to the present configuration, in the first mode, when the operation tool is operated from the neutral region to the other-side region, the hydraulic cylinder is able to be operated at a high speed. On the other hand, in the second mode, when the operation tool is operated from the neutral region to the other-side region, the hydraulic cylinder is able to be operated at a low speed.

As a result, for example, in a case where the hydraulic cylinder is applied to a configuration in which the bucket is swung, it is possible to select an appropriate work form according to a work status, such as a work form in which soil, sand, and the like are quickly discharged from the bucket or a work form in which soil, sand, and the like are discharged at a standard speed, and thereby the usability is improved.

In the present invention, the hydraulic cylinder may be configured to be of a reciprocating type, and the switching control valve may be configured such that return oil from the hydraulic cylinder in while the switching control valve is switched to the other-side first operation position joins pressurized oil supplied to the hydraulic cylinder.

According to the present configuration, the return oil from the hydraulic cylinder is effectively used, and thus the operation state of the hydraulic cylinder is able to be switched between the first operation state and the second operation state with a simple configuration.

In the present invention, the hydraulic actuator may be a hydraulic cylinder, hydraulic oil from the hydraulic pump may be supplied to a first port for operating the hydraulic cylinder in a first operation direction in the hydraulic cylinder at the one-side operation position, hydraulic oil from the hydraulic pump may be supplied to a second port for operating the hydraulic cylinder in a second operation direction in the hydraulic cylinder at the other-side first operation position, and supply of hydraulic oil from the hydraulic pump to the first port and the second port may be blocked, and the first port and the second port may be caused to communicate with each other to be connected to a drain oil passage through which hydraulic oil is discharged to a tank at the other-side second operation position.

According to the present configuration, when the operation tool is operated from the neutral region to the other-side region in the second mode, both-side ports of the hydraulic cylinder are able to be connected to the drain oil passage to be in a floating state.

In the present invention, the switching control valve may be configured to switch an operation position by slide-operating a spool with a hydraulic pilot operation pressure, and the at least one electromagnetic proportional valve may include a plurality of electromagnetic proportional valves, as the electromagnetic proportional valve, a one-side electromagnetic proportional valve configured to change a pilot operation pressure for slide-operating the spool on one side and an other-side electromagnetic proportional valve configured to change a pilot operation pressure for slide-operating the spool on an other side may be provided.

According to the present configuration, since the switching control valve causes the spool to be slide-operated by the hydraulic pilot operation pressure, even in a case where an amount of stroke to be slid is large, the switching operation is able to be smoothly performed with a strong hydraulic operation force.

In the present invention, the operation tool may be configured of a swing-operable operation lever, and the mode switching means may be configured of a switch provided on a grip portion of the operation tool to be finger-operable.

According to the present configuration, the operator is able to switch the control mode by the finger operation of the switch while gripping and operating the operation lever. Therefore, the operability is excellent without the inconvenience of changing the hand.

In the present invention, as the other-side region of the operation tool, an other-side first region located on a neutral region side and an other-side second region located on a side opposite to the neutral region may be set, the mode switching means may be configured to switch the control mode of the control unit to a third mode, and in the third mode, the control unit may be configured to supply the current value corresponding to the other-side first operation position to the electromagnetic proportional valve when the operation tool is operated in the other-side first region, and supply the current value corresponding to the other-side second operation position to the electromagnetic proportional valve when the operation tool is operated in the other-side second region.

According to the present configuration, if the third mode is set by the mode switching means, when the operation tool is operated to the other-side first region, the switching control valve is operated to be switched to the other-side first operation position.

In addition, when the operation tool is operated from the other-side first region to the other-side second region, the switching control valve is operated to be switched from the other-side first operation position to the other-side second operation position.

That is, in the first mode and the second mode, the switching control valve is able to be switched to three positions based on the operation of the operation tool, whereas in the third mode, the switching control valve is able to be switched to four positions of the one-side operation position, the neutral position, the other-side first operation position, and the other-side second operation position based on the operation of the operation tool.

Therefore, the switching control valve is able to be used by changing between the three-position switching state and the four-position switching state, and thereby convenience is improved.

### BRIEF DESCRIPTION OF THE DRAWINGS

FIG. 1 is a side view of a tractor provided with a front loader;

FIG. 2 is a hydraulic circuit diagram of a hydraulic control unit;

FIG. 3 is a diagram illustrating an operation lever and a control configuration;

FIG. 4 is a perspective view illustrating a grip portion of the operation lever;

FIG. 5 is a diagram illustrating change characteristics between a lever operation angle and a current value;

FIG. 6 is a diagram illustrating an operation lever and a control configuration of another embodiment;

FIG. 7 is a diagram illustrating change characteristics between a lever operation angle and a current value in another embodiment; and

FIG. 8 is a diagram illustrating change characteristics between a lever operation angle and a current value in another embodiment.

### DESCRIPTION OF THE INVENTION

Hereinafter, embodiments of the present invention will be described with reference to the drawings.

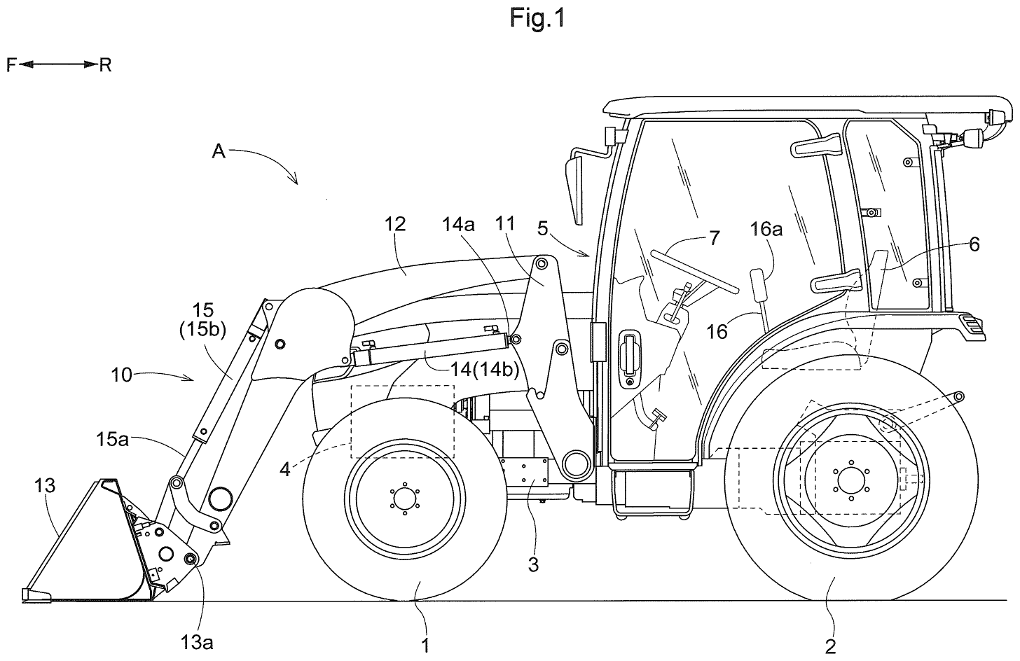

FIG. 1 illustrates a tractor A as an example of a work vehicle including a front loader 10. In the same drawing, a front side of the tractor is indicated by “F”, and a rear side is indicated by “R”.

The tractor A includes an engine 4 at a front portion of a vehicle body 3 having a front wheel 1 and a rear wheel 2, and accommodates a driver's seat 6 and a steering wheel 7 inside a cabin 5 that covers a driving unit at a rear portion of the vehicle body 3.

The front loader 10 includes left and right columnar frames 11, left and right booms 12, one bucket 13, left and right boom hydraulic cylinders 14 (hereinafter, referred to as boom cylinders) as hydraulic actuators, and a bucket hydraulic cylinder 15 (hereinafter, referred to as a bucket cylinder) as a hydraulic actuator. The front loader 10 is able to be attached to and detached from the vehicle body 3 by attaching the left and right columnar frames 11 to the vehicle body 3 in a detachable manner, and thus the entire front loader 10 is able to be attached to and detached from the vehicle body 3.

Front end portions of the left and right booms 12 protrude toward the front side of the vehicle body 3, and base end portions thereof are supported by upper ends of the corresponding left and right columnar frames 11 such that the front end portions are able to move vertically. Further, the bucket 13 is supported to be vertically swingable about a support shaft 13a in a lateral posture at the front end portions of the left and right booms 12.

The boom cylinder 14 is a double-acting type, and a boom-side piston rod 14a is connected to the columnar frame 11, and a bottom of a boom-side cylinder portion 14b is connected to the boom 12. The bucket cylinder 15 is a double-acting type, and a bucket-side piston rod 15a is connected to the bucket 13, and a boom-side cylinder portion 15b of the bucket cylinder 15 is connected to the boom 12.

From this configuration, the front loader 10 lifts a distal end of the boom 12 by the extension of the boom cylinder 14 and lowers the distal end of the boom 12 by the contraction of the boom cylinder 14. In addition, the front loader 10 performs a dump operation of swinging the bucket 13 downward about the support shaft 13a by the extension of the bucket cylinder 15, and performs a scooping operation of swinging the bucket 13 upward about the support shaft 13a by the contraction of the bucket cylinder 15.

As illustrated in FIG. 1, the tractor A includes an operation lever 16 as an example of an operation tool in the vicinity of the driver's seat 6. The front loader 10 enables a telescopic operation of the boom cylinder 14 and a telescopic operation of the bucket cylinder 15 via the operation of the operation lever 16. As illustrated in FIG. 4, the operation lever 16 is operable in a Y direction and a Z direction which are orthogonal to each other in a plan view, controls the bucket 13 with being operated in the Y direction, and controls the boom 12 with being operated in the Z direction.

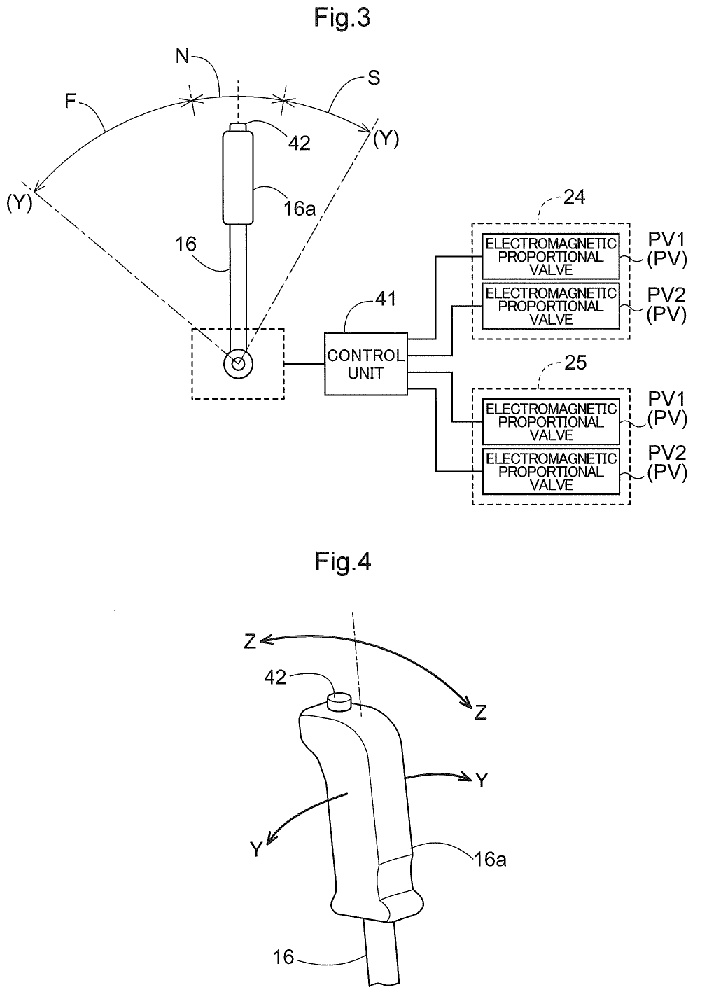

As illustrated in FIG. 3, the operation lever 16 is able to be operated to switch between a scoop region E as a one-side region where the scooping operation of the bucket 13 is performed, a neutral region N where the operation of the bucket cylinder 15 is stopped, and a dump region F as an other-side region where the dump operation of the bucket 13 is performed, by performing a swing operation in the Y direction. In addition, the operation lever 16 is able to be operated to switch between the one-side region where the lifting operation of the boom 12 is performed, the neutral region N where the operation of the boom 12 is stopped, and the other-side region where the lowering operation of the boom 12 is performed, by performing the swing operation in the Z direction.

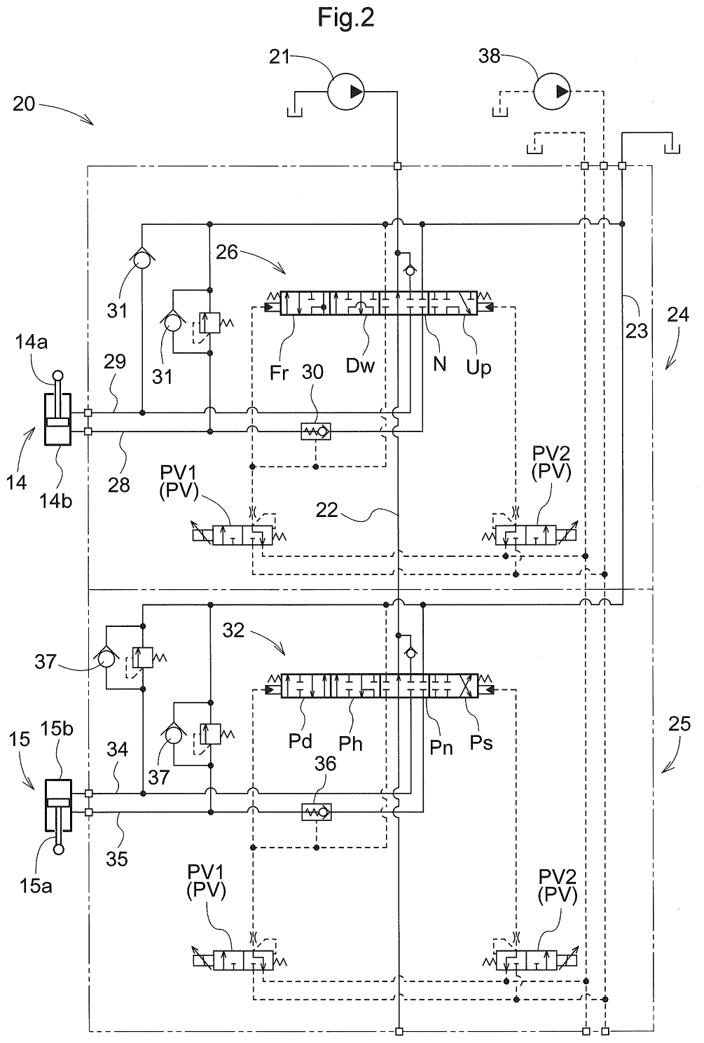

As illustrated in FIG. 2, the tractor A includes a hydraulic control unit 20 that controls the operations of the boom cylinder 14 and the bucket cylinder 15. The hydraulic control unit 20 includes a hydraulic oil flow passage 22 through which hydraulic oil of a hydraulic pump 21 driven by the engine 4 is supplied, a drain oil passage 23 through which the hydraulic oil is discharged to a tank, a boom control unit 24 that switches an operation state of the boom cylinder 14, and a bucket control unit 25 that switches an operation state of the bucket cylinder 15.

The boom control unit 24 includes a boom control valve 26 as a switching control valve that supplies and discharges the hydraulic oil supplied through the hydraulic oil flow passage 22 to and from the boom cylinder 14, and a pair of electromagnetic proportional valves PV for the switching operation of the boom control valve 26. In addition, the boom control unit 24 includes a first flow passage 28 that supplies hydraulic oil from the boom control valve 26 to one cylinder chamber extending the boom cylinder 14, a second flow passage 29 that supplies hydraulic oil from the boom control valve 26 to the other cylinder chamber contracting the boom cylinder 14, a pilot operation type check valve 30 interposed in the first flow passage 28, a relief valve 31 for pressure adjustment, and the like.

The bucket control unit 25 includes a bucket control valve 32 as a switching control valve that supplies and discharges the hydraulic oil supplied through the hydraulic oil flow passage 22 to and from the bucket cylinder 15, and a pair of electromagnetic proportional valves PV for a switching operation of the bucket control valve 32. In addition, the bucket control unit 25 includes a third flow passage 34 that supplies the hydraulic oil from the bucket control valve 32 to one cylinder chamber extending the bucket cylinder 15, a fourth flow passage 35 that supplies the hydraulic oil from the bucket control valve 32 to the other cylinder chamber contracting the bucket cylinder 15, a pilot operation type check valve 36 interposed in the fourth flow passage 35, a relief valve 37 for pressure adjustment, and the like.

The boom control valve 26 is a four-position switching type control valve that is able to be switched to a lifting position Up as a one-side operation position, a neutral position N, a lowering position DW as an other-side first operation position, and a floating position Fr as an other-side second operation position in this order as control switching positions. At the lifting position Up, the hydraulic oil flow passage 22 and the first flow passage 28 communicate with each other, and the hydraulic oil from the hydraulic pump 21 is supplied to the first port for lifting of the boom cylinder 14. Accordingly, the boom 12 is operated in a lifting direction (‘first operation direction). In this case, the second flow passage 29 communicates with the discharge port. At the neutral position N, the hydraulic oil flow passage 22, the first flow passage 28, and the second flow passage 29 are blocked each other, and the hydraulic oil flow passage 22 communicates with a downstream side (discharge side). At the lowering position DW, the hydraulic oil flow passage 22 and the second flow passage 29 communicate with each other, and the hydraulic oil from the hydraulic pump 21 is supplied to the second port for lowering of the boom cylinder 14. Accordingly, the boom 12 is operated in the lowering direction (second operation direction). In this case, the first flow passage 28 communicates with the discharge port. In addition, at the lowering position DW, the pilot operation pressure is applied to the check valve 30 interposed in the first flow passage 28 to enable the discharge of the hydraulic oil. At the floating position Fr, the hydraulic oil flow passage 22, the first flow passage 28, and the second flow passage 29 are blocked each other, the first flow passage 28 and the second flow passage 29 are communicated with each other, and the first flow passage 28 and the second flow passage 29 further communicate with the drain oil passage 23.

The bucket control valve 32 is a four-position switching type control valve that is able to switch between the scoop position Ps as the one-side operation position, the neutral position Pn, the rapid dump position Ph as the other-side first operation position, and the standard dump position Pd as the other-side second operation position in this order. At the scoop position Ps, the hydraulic oil flow passage 22 and the fourth flow passage 35 communicate with each other, and the drain oil passage 23 and the third flow passage 34 communicate with each other. When the bucket control valve 32 is switched to the scoop position Ps, the bucket cylinder 15 is operated to the scooping operation side as one of the sides in the extending and contracting directions. At the neutral position Pn, the hydraulic oil flow passage 22, the third flow passage 34, and the fourth flow passage 35 are blocked each other, and the hydraulic oil flow passage 22 communicates with the downstream side. In this case, the operation of the bucket cylinder 15 is stopped.

At the rapid dump position Ph, the hydraulic oil flow passage 22 and the third flow passage 34 communicate with each other, and the waste oil from the fourth flow passage 35 is also joined to the third flow passage 34. When the bucket control valve 32 is switched to the rapid dump position, the bucket cylinder 15 is operated in a high-speed operation state as the first operation state toward the dump operation side as the other of the sides in the extending and contracting directions.

At the standard dump position Pd, the hydraulic oil flow passage 22 and the third flow passage 34 communicate with each other, and the drain oil passage 23 and the fourth flow passage 35 communicate with each other. That is, waste oil from the fourth flow passage 35 is discharged to the tank side. When the bucket control valve 32 is switched to the standard dump position, the bucket cylinder 15 is operated in a low-speed operation state as the second operation state toward the dump operation side.

At the rapid dump position Ph and the standard dump position Pd, the pilot operation pressure is applied to the check valve 36 interposed in the fourth flow passage 35 to enable the discharge of the hydraulic oil from the other cylinder chamber of the bucket cylinder 15.

A high-speed operation state is used in work of easily discharging a loaded object that is difficult to separate, such as soil and sand, by dumping the bucket 13 at a high speed. On the other hand, the low-speed operation state is used in work of slowly discharging the loaded object scooped by the bucket 13 downwards by dumping the bucket 13 at a low speed.

The boom control valve 26 is configured to slide-operate a spool with a hydraulic pilot operation pressure to switch an operation position. Then, the pilot pressure is controlled by each of the pair of electromagnetic proportional valves PV of the electromagnetic proportional type, and the spool of the boom control valve 26 is shifted by the pilot pressure to be switched to each of the above-described operation positions.

Similarly to the boom control valve 26, the bucket control valve 32 is configured to slide-operate the spool with the hydraulic pilot operation pressure controlled by the operation of the electromagnetic proportional valve to switch the operation positions. The electromagnetic proportional valve PV includes a one-side electromagnetic proportional valve PV1 in which a pilot operation pressure for slide-operating the spool on one side is changeable, and an other-side electromagnetic proportional valve PV2 in which a pilot operation pressure for slide-operating the spool on the other side is changeable. Then, the pilot pressure is controlled by each of the pair of electromagnetic proportional valves PV of the electromagnetic proportional type, and the spool of the bucket control valve 32 is shifted by the pilot pressure to be switched to each of the above-described operation positions. The electromagnetic proportional valve PV is operated by the hydraulic oil from the hydraulic pump 38 for a pilot.

In a case where the operation lever 16 is in the neutral region N, the control unit 41 operates the spool of the bucket control valve 32 to the neutral position Pn. In addition, when the operation lever 16 is in the scoop region E, the control unit 41 supplies a current value corresponding to the scoop position Ps to the target electromagnetic proportional valve PV1. Accordingly, the spool of the bucket control valve 32 is operated to be switched to the scoop position Ps.

The control unit 41 is switchable between a first mode and a second mode in which a control operation in a case where the operation lever 16 is operated in the dump region F is different.

The operation lever 16 includes a mode switching switch 42 as mode switching means capable of switching the control mode of the control unit 41 between the first mode and the second mode. As illustrated in FIG. 4, the mode switching switch 42 is provided to be operable by a finger of a hand gripping a grip portion 16a on a lateral side of the grip portion 16a of the operation lever 16. The mode switching switch 42 is able to switch the control mode of the control unit 41 between the first mode and the second mode by repeating the pressing operation.

In the first mode, the control unit 41 is configured to supply a current value corresponding to the rapid dump position Ph to the target electromagnetic proportional valve PV2 when the operation lever 16 is operated from the neutral region N to the dump region F. In addition, in the second mode, the control unit 41 is configured to supply a current value corresponding to a standard dump position to the electromagnetic proportional valve PV2 when the operation lever 16 is operated from the neutral region N to the dump region F.

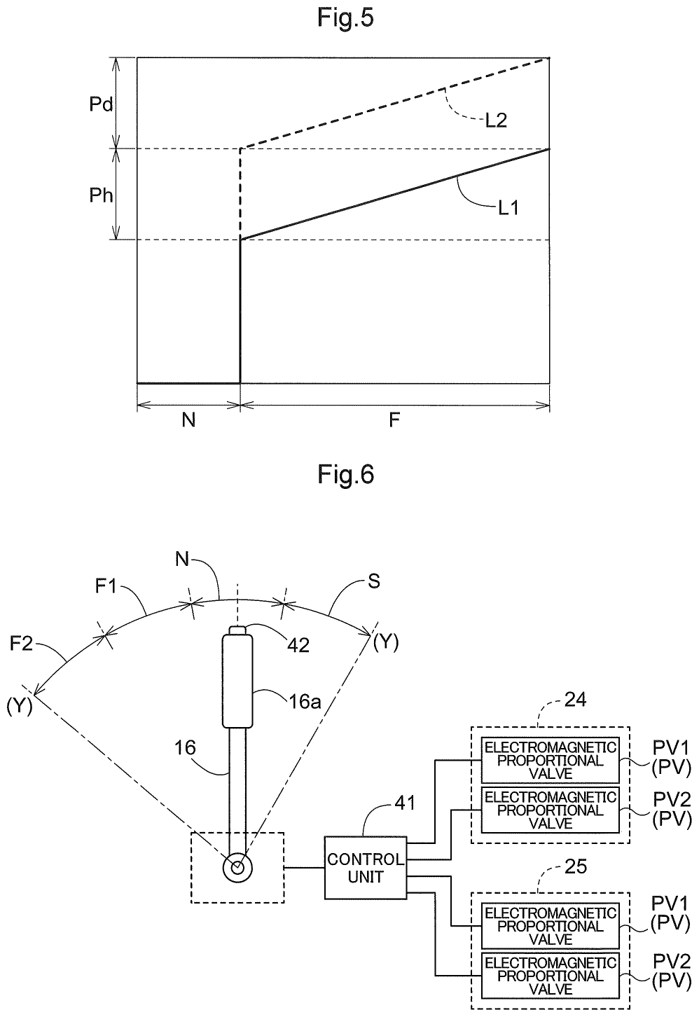

FIG. 5 illustrates a change in a current value supplied to the electromagnetic proportional valve PV with respect to a change in a lever tilt angle when the operation lever 16 is operated from the neutral region N to the dump region F along the Y direction.

In FIG. 5, a line L1 indicates a change characteristic corresponding to the first mode, and a line L2 indicates a change characteristic corresponding to the second mode.

In the first mode, as illustrated in the line L1, when the operation lever 16 is in the neutral region N, the current value supplied to the electromagnetic proportional valve PV by the control unit 41 is zero, and the spool of the bucket control valve 32 is biased to return to the neutral position Pn with a biasing spring (not illustrated). When the operation lever 16 is operated to the dump region, a current having a value required for switching the bucket control valve 32 to the rapid dump position Ph is supplied to the electromagnetic proportional valve PV2. The current is supplied while the current value gradually increases as the operation lever 16 is sequentially operated in a direction away from the neutral position in the dump region F. That is, the bucket cylinder 15 is dump-operated while the speed gradually increases as the lever tilt angle increases.

In the second mode, as illustrated in the line L2, when the operation lever 16 is in the neutral region N, the current value supplied to the electromagnetic proportional valve PV by the control unit 41 is zero, and when the operation lever 16 is operated to the dump region F, the control unit 41 supplies a current of a value necessary for switching the bucket control valve 32 to the standard dump position Pd with respect to the electromagnetic proportional valve PV2. The current is supplied while the current value gradually increases as the operation lever 16 is sequentially operated in a direction away from the neutral position n in the dump region F. That is, the bucket cylinder 15 is dump-operated while the speed gradually increases as the lever tilt angle increases.

In a case where the operation lever 16 is in the neutral region N, the control unit 41 operates the spool of the boom control valve 26 to the neutral position N. In addition, when the operation lever 16 is in the one-side region where the boom 12 is lifted, the control unit 41 supplies a current value corresponding to the boom lifting operation to the target electromagnetic proportional valve PV1. As a result, the spool of the boom control valve 26 is operated to be switched to the lifting position.

The control unit 41 is switchable between the first mode and the second mode in which a control operation in a case where the operation lever 16 is operated to the other-side region where the boom 12 is lowered is different.

The control unit 41 includes a boom operation mode switching switch (not illustrated) as mode switching means capable of switching the control mode of the control unit 41 between the first mode and the second mode. The boom operation mode switching switch may be common to the mode switching switch 42 or may be separately provided. The boom operation mode switching switch is able to switch the control mode of the control unit 41 between the first mode and the second mode by repeating the pressing operation.

In the first mode, the control unit 41 is configured to supply a current value corresponding to the boom lowering operation to the target electromagnetic proportional valve PV2 when the operation lever 16 is operated from the neutral region N to the other-side region. In addition, in the second mode, when the operation lever 16 is operated from the neutral region N to the other-side region, a current value corresponding to the floating position is supplied to the electromagnetic proportional valve PV2.

A change in the current value supplied to the electromagnetic proportional valve PV with respect to a change in the lever tilt angle when the operation lever 16 is operated to the lowering position from the neutral region N along the Z direction is set, for example, in the same manner as the change characteristic illustrated in FIG. 5.

As described above, the speed when the bucket 13 is subjected to the dump operation is able to be switched by the selective operation of the mode switching switch 42. In addition, the operation content of the boom 12 is able to be switched.

### OTHER EMBODIMENTS

(1) In the above-described embodiment, the mode switching switch 42 is configured to switch between the first mode and the second mode. However, the mode switching switch 42 may be also further configured to switch to a third mode, and the control unit 41 may be configured to perform the following operation in the third mode. In this case, the mode switching switch 42 is not limited to the push operation type, and a configuration of a rotary type switching switch may be employed, which is not illustrated.

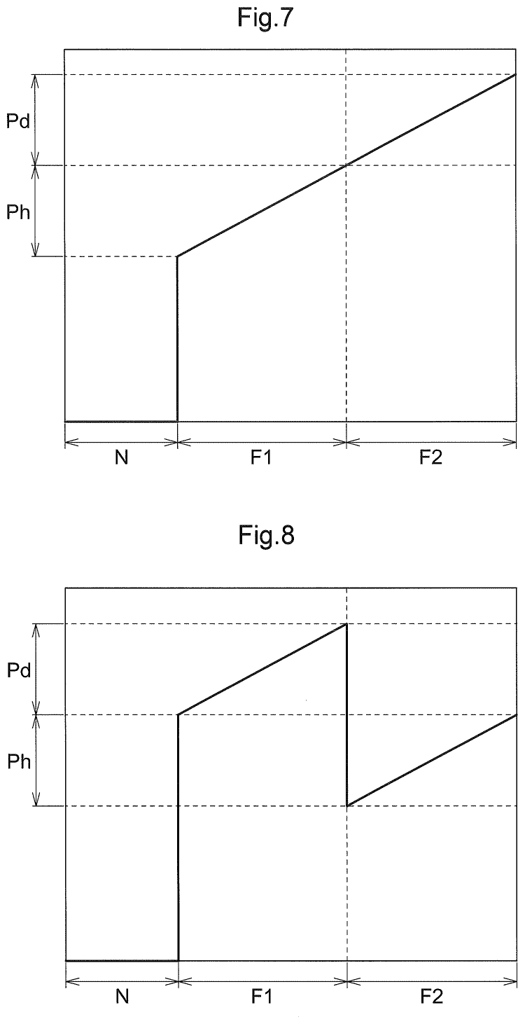

As illustrated in FIG. 6, a first dump region F1 as the other-side first region located on the neutral region N side and a second dump region F2 as the other-side second region located opposite to the neutral region N are set as the other-side region (dump region) of the operation lever 16, and the mode switching switch 42 is configured to switch to the third mode in addition to the first mode and the second mode. In the third mode, when the operation lever 16 is operated to the first dump region F1, as illustrated in FIG. 7, the control unit 41 supplies the current value corresponding to the rapid dump position Ph to the electromagnetic proportional valve PV, and when the operation lever 16 is operated to the second dump region F2, the control unit 41 supplies the current value corresponding to the standard dump position Pd to the electromagnetic proportional valve PV.

In addition, as illustrated in FIG. 8, a configuration may be adopted in which, when the operation lever 16 is operated to the first dump region F1, the current value corresponding to the standard dump position Pd is supplied to the electromagnetic proportional valve PV, and when the operation lever 16 is operated to the second dump region F2, the current value corresponding to the rapid dump position Ph is supplied to the electromagnetic proportional valve PV.

With such a configuration, the switching control valve (bucket control valve 32) is able to be used by substantially changing between the three-position switching state and the four-position switching state, and thereby convenience is improved.

(2) In the above-described embodiment, as the mode switching means, the mode switching switch 42 is provided in a state of being capable of being operated by a finger on the grip portion of the operation lever. However, instead of this configuration, the operation panel may include the mode switching switch 42, or the mode may be changed by using a touch panel type display or the like instead of the switch.

(3) In the above-described embodiment, as the hydraulic cylinder, the hydraulic cylinder that is applied to the bucket cylinder of the front loader mounted on the tractor is described. However, the present invention is not limited to the front loader and is able to be applied to various devices such as a wheel loader and a hydraulic shovel. In addition, the present invention is not limited to the bucket cylinder as the operation target, and is able to be applied to a hydraulic cylinder that operates various other operated portions. In addition, the present invention is not limited to the hydraulic cylinder, and is also able to be applied to a hydraulic control device that controls operations of other hydraulic actuators such as a hydraulic motor.

### INDUSTRIAL APPLICABILITY

The present invention is able to be applied to a hydraulic control device that controls a hydraulic cylinder.

### DESCRIPTION OF REFERENCE NUMERALS

15: bucket cylinder (hydraulic cylinder)
16: operation lever (operation tool)
16a: grip portion
21: hydraulic pump
26: boom control valve (switching control valve)
32: bucket control valve (switching control valve)
41: control unit
42: mode switching switch (mode switching means)
PV: electromagnetic proportional valve
PV1: one-side electromagnetic proportional valve
PV2: other-side electromagnetic proportional valve
E: scoop region (one-side region)
N: neutral region
F: dump region (other-side region)
F1: first dump region (other-side first region)
F2: second dump region (other-side second region)
Ps: scoop position (one-side operation position)
Pn: neutral position
Ph: rapid dump position (other-side first operation position)
Pd: standard dump position (other-side second operation position)
Up: lifting position (one-side operation position)
DW: lowering position (other-side first operation position)
Fr: floating position (other-side second operation position)

1. A hydraulic control device, comprising:
a switching control valve configured to switch a supply and discharge state of hydraulic oil;
at least one electromagnetic proportional valve configured to be used for a switching operation of the switching control valve;
a control unit configured to control an operation of the electromagnetic proportional valve based on an operation command of an operation tool; and
a mode switching switch configured to switch a control mode of the control unit between a first mode and a second mode,
wherein the operation tool is capable of being operated to a one-side region, a neutral region, and an other-side region,
wherein the switching control valve is capable of being switched between a one-side operation position where the switching control valve is switched in response to an operation of the operation tool to the one-side region, a neutral position where the switching control valve is switched when the operation tool is not operated, an other-side first operation position where the switching control valve is switched when the operation tool is operated to the other-side region, and an other-side second operation position where the switching control valve is switched when the operation tool is operated to the other-side region, which is different from the first operation state, and
wherein the control unit is configured to,
supply a current value corresponding to the other-side first operation position to the electromagnetic proportional valve when the operation tool is operated from the neutral position to the other-side region in the first mode, and
supply a current value corresponding to the other-side second operation position to the electromagnetic proportional valve when the operation tool is operated from the neutral position to the other-side region in the second mode.

2. The hydraulic control device according to claim 1, wherein the switching control valve:
switches the supply and discharge state of hydraulic oil with respect to a hydraulic actuator from a hydraulic pump,
switches the supply and discharge state to operate the hydraulic actuator in a first operation direction at the one-side operation position,
switches the supply and discharge state to operate the hydraulic actuator in a first operation state in a second operation direction at the other-side first operation position, and
switches the supply and discharge state to operate the hydraulic actuator in a second operation state different from the first operation state in the second operation direction at the other-side second operation position.

3. The hydraulic control device according to claim 2,
wherein the hydraulic actuator is a hydraulic cylinder, the first operation state is a high-speed operation state where the hydraulic cylinder is operated at a high speed, and the second operation state is a low-speed operation state where the hydraulic cylinder is operated at a low speed.

4. The hydraulic control device according to claim 3,
wherein the hydraulic cylinder is configured to be of a reciprocating type, and
wherein the switching control valve is configured such that return oil from the hydraulic cylinder while the switching control valve is switched to the other-side second operation position joins pressurized oil supplied to the hydraulic cylinder.

5. The hydraulic control device according to claim 1, wherein:
the hydraulic actuator is a hydraulic cylinder,
hydraulic oil from the hydraulic pump is supplied to a first port for operating the hydraulic cylinder in a first operation direction in the hydraulic cylinder at the one-side operation position,
hydraulic oil from the hydraulic pump is supplied to a second port for operating the hydraulic cylinder in a second operation direction in the hydraulic cylinder at the other-side first operation position, and
supply of hydraulic oil from the hydraulic pump to the first port and the second port is blocked, and the first port and the second port are caused to communicate with each other to be connected to a drain oil passage through which hydraulic oil is discharged to a tank at the other-side second operation position.

6. The hydraulic control device according to claim 1,
wherein the switching control valve is configured to switch an operation position by slide-operating a spool with a hydraulic pilot operation pressure, and
wherein the at least one electromagnetic proportional valve comprises a plurality of electromagnetic proportional valves, as the electromagnetic proportional valve, a one-side electromagnetic proportional valve configured to change a pilot operation pressure for slide-operating the spool on one side and an other-side electromagnetic proportional valve configured to change a pilot operation pressure for slide-operating the spool on an other side are provided.

7. The hydraulic control device according to claim 1,
wherein the operation tool is configured of a swing-operable operation lever, and
wherein the mode switching switch is configured of a switch provided on a grip portion of the operation tool to be finger-operable.

8. The hydraulic control device according to claim 1,
wherein as the other-side region of the operation tool, an other-side first region located on a neutral region side and an other-side second region located on a side opposite to the neutral region are set,
the mode switching switch is configured to switch the control mode of the control unit to a third mode, and
wherein in the third mode, the control unit is configured to:
supply the current value corresponding to the other-side first operation position to the electromagnetic proportional valve when the operation tool is operated in the other-side first region, and
supply the current value corresponding to the other-side second operation position to the electromagnetic proportional valve when the operation tool is operated in the other-side second region.
